(19) United States
(12) Patent Application Publication
(10) Pub. No.: US 2019/0184852 A1
(43) Pub. Date: Jun. 20, 2019

(54) DEVICE TEMPERATURE ADJUSTING APPARATUS

(71) Applicant: DENSO CORPORATION, Kariya-city (JP)

(72) Inventors: Masayuki TAKEUCHI, Kariya-city (JP); Yasumitsu OMI, Kariya-city (JP); Takashi YAMANAKA, Kariya-city (JP); Yoshiki KATO, Kariya-city (JP); Takeshi YOSHINORI, Kariya-city (JP); Koji MIURA, Kariya-city (JP)

(21) Appl. No.: 16/285,302

(22) Filed: Feb. 26, 2019

Related U.S. Application Data
(63) Continuation of application No. PCT/JP2017/028054, filed on Aug. 2, 2017.

(30) Foreign Application Priority Data
Sep. 9, 2016 (JP) 2016-176785

(51) Int. Cl. B60L 58/26; F28D 15/06; B60H 1/32; B60H 1/00; H01M 10/613; H01M 10/663; H01M 10/625; H01M 10/6552; B60L 50/60

(52) U.S. Cl. CPC B60L 58/26; F28D 15/06; B60H 1/3205; B60H 1/00278; H01M 10/613; B60Y 2306/05; H01M 10/625; H01M 10/6552; B60L 50/66; H01M 2220/20; B60Y 2200/91; H01M 10/663

(57) ABSTRACT

A device temperature adjusting apparatus in which working fluid circulates is mounted on a vehicle and controls a temperature of a target device. The device temperature adjusting apparatus includes a heat absorbing portion that evaporates the working fluid by causing the working fluid to absorb heat from the target device, and a heat releasing portion condenses the working fluid by causing heat release from the working fluid. The device temperature adjusting apparatus includes a forward path portion that defines a forward flow passage and a return path portion. The heat releasing portion is disposed in an inside air circulation path through which inside air circulates while vehicle interior air conditioning is performed by an air conditioning unit that blows out temperature-controlled air to an interior of the vehicle.

### CROSS REFERENCE TO RELATED APPLICATIONS

The present application is a continuation application of International Patent Application No. PCT/JP2017/028054 filed on Aug. 2, 2017, which designated the United States and claims the benefit of priority from Japanese Patent Application No. 2016-176785 filed on Sep. 9, 2016. The entire disclosures of all of the above applications are incorporated herein by reference.

### TECHNICAL FIELD

The present disclosure relates to a device temperature adjusting apparatus for controlling a temperature of a target device.

### BACKGROUND

A general cooling device transfers heat by circulation of working fluid in an order of a heat receiving portion, a heat release path, a heat releasing portion, a return path, and the heat receiving portion. More specifically, heat transferred from a semiconductor switching element to a heat receiving plate of the heat receiving portion heats the working fluid which is liquid and supplied onto the heat receiving plate, and instantaneously vaporizes the working fluid. Steam having received latent heat of vaporization from the heat receiving plate flows from a discharge port of the heat receiving portion to the heat release path, and condenses at the heat releasing portion to release the heat to outside air.

The heat releasing portion disposed in a front part of a vehicle cools and condenses the working fluid by using airflow generated during traveling.

### SUMMARY

According to an aspect of the present disclosure, a device temperature adjusting apparatus is mounted on a vehicle and controls a temperature of a target device by a phase transition of working fluid between a liquid phase and a gas phase, the working fluid circulating in the device temperature adjusting apparatus. The device temperature adjusting apparatus includes: a heat absorbing portion that evaporates the working fluid by causing the working fluid to absorb heat from the target device; a heat releasing portion disposed above the heat absorbing portion, and condensing the working fluid by causing heat release from the working fluid; a forward path portion that defines a forward flow passage through which the working fluid flows from the heat releasing portion to the heat absorbing portion; and a return path portion that defines a return flow passage through which the working fluid flows from the heat absorbing portion to the heat releasing portion. The heat releasing portion is disposed in an inside air circulation path through which inside air circulates while vehicle interior air conditioning is performed by an air conditioning unit that blows out temperature-controlled air to an interior of the vehicle.

### BRIEF DESCRIPTION OF THE DRAWINGS

FIG. 1 is a schematic diagram showing a schematic configuration of a device temperature adjusting apparatus in a first embodiment.

FIG. 2 is a schematic diagram schematically showing a vehicle on which the device temperature adjusting apparatus is mounted in the first embodiment.

FIG. 3 is a schematic cross-sectional view showing a schematic configuration of an air conditioning unit on which a condenser of the device temperature adjusting apparatus is disposed in the first embodiment.

FIG. 4 is a schematic cross-sectional view showing a schematic configuration of an air conditioning unit on which a condenser of a device temperature adjusting apparatus is disposed in a second embodiment.

FIG. 5 is a block diagram showing electrical connection of a controller included in a device temperature adjusting apparatus in a third embodiment.

FIG. 6 is a flowchart showing a control process executed by the controller in the third embodiment.

### EMBODIMENTS

Embodiments of the present disclosure will be hereinafter described with reference to the drawings. In the respective embodiments described hereinafter, identical or equivalent parts in the figures are given identical reference numbers.

### First Embodiment

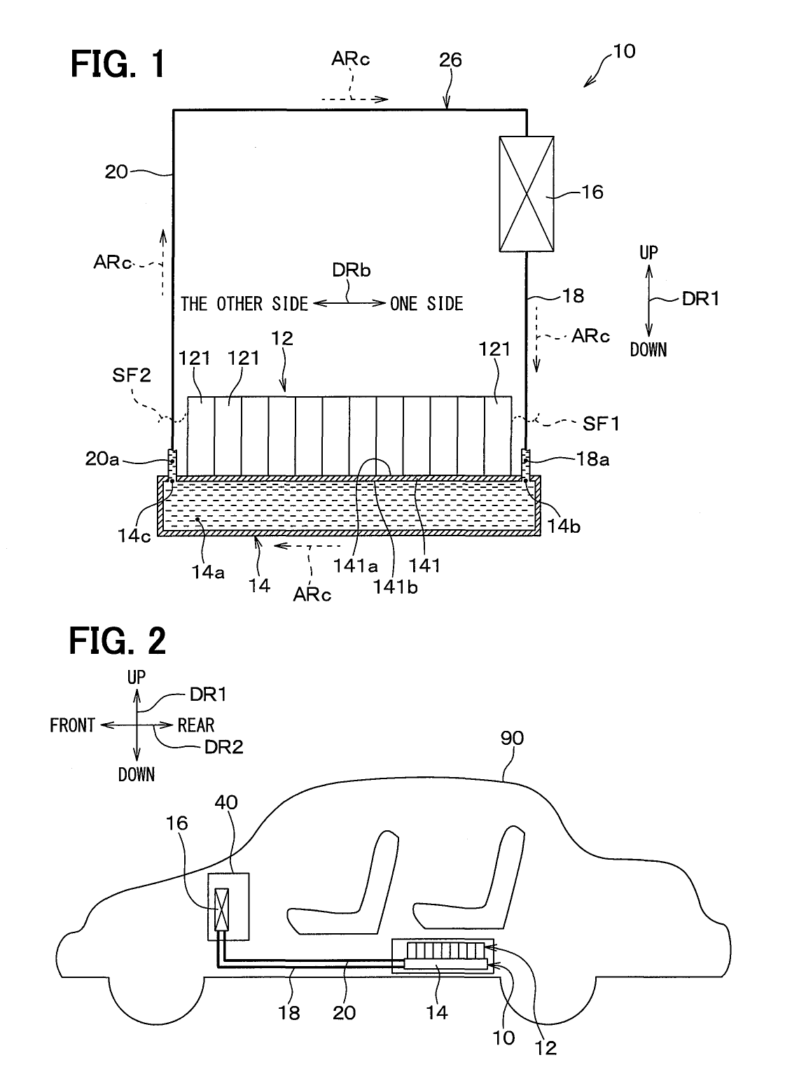

As shown in FIG. 2, a device temperature adjusting apparatus 10 of the present embodiment shown in FIG. 1 is mounted on an electric vehicle 90 such as an electric car and a hybrid vehicle. In the present embodiment, the device temperature adjusting apparatus 10 functions as a cooling device which cools a secondary battery 12 (hereinafter also simply referred to as “battery 12”) mounted on the electric vehicle 90. Accordingly, a target device to be cooled by the device temperature adjusting apparatus 10 is the battery 12.

According to the electric vehicle 90 (hereinafter also simply referred to as “vehicle 90”) on which the device temperature adjusting apparatus 10 is mounted, electric energy, which is stored in a power storage device (i.e., battery pack) including the secondary battery 12 as a main component, is supplied to a motor via an inverter or the like to allow traveling of the vehicle 90. The battery 12 generates self-heat during use of the vehicle, such as traveling of the vehicle. When the temperature of the battery 12 becomes excessively high, deterioration of battery cells 121 constituting the battery 12 develops. It is therefore necessary to set limitations to output and input levels of the battery cells 121 to reduce self-heat. Accordingly, a cooling device for maintaining the temperature of the battery 12 at a predetermined temperature or lower is required to secure output and input levels of the battery cells 121.

Moreover, the battery temperature increases not only during traveling of the vehicle but also during parking in the summertime. In addition, the power storage device is often disposed under a floor or under a trunk room of the vehicle 90. In this case, the heat amount per unit time given to the battery 12 is small, but the battery temperature gradually increases during long-time parking. When the battery 12 is left in a high temperature condition, the life of the battery 12 considerably decreases. It is therefore demanded to maintain the battery temperature at a low temperature by cooling the battery 12 or by other methods, even while the vehicle 90 is left in a parking state.

Moreover, as shown in FIGS. 1 and 2, the battery 12 is constituted as a battery pack including a plurality of the battery cells 121. When the respective battery cells 121 have different temperatures, deterioration of the respective battery cells 121 develops in an unbalanced manner. In this case, performance of the power storage device drops. This drop of performance is produced in accordance with characteristics of the most deteriorated battery cell 121 which determine input-output characteristics of the power storage device. Accordingly, for achieving desired performance of the power storage device for a long period of time, temperature equalization for reducing temperature variations between the plurality of battery cells 121 is essential.

For another type of cooling device which cools the battery 12, air blowing by a blower, air cooling or water cooling using a refrigeration cycle, or a direct refrigerant cooling system has been generally adopted. However, a blower only blows air in an interior of the vehicle, and therefore has low cooling performance. Furthermore, air blowing by the blower cools the battery 12 by using sensible heat of air. In this case, a temperature difference increases between the airflow upstream side and the airflow downstream side, wherefore temperature variations between the battery cells 121 are difficult to sufficiently reduce. The refrigeration cycle system has high cooling performance, but a heat exchange portion included in this system for heat exchange with the battery cells 121 performs sensible heat cooling in both air cooling and water cooling. Accordingly, sufficient reduction of temperature variations between the battery cells 121 is difficult to achieve. In addition, driving a compressor or a cooling fan of a refrigeration cycle during parking is undesirable in view of possibilities of increase in power consumption, noise, or other problems.

In consideration of these circumstances, the device temperature adjusting apparatus 10 of the present embodiment adopts a thermosiphon system which cools the battery 12 by natural circulation of a refrigerant without using a compressor.

More specifically, as shown in FIG. 1, the device temperature adjusting apparatus 10 includes a battery cooler 14, a condenser 16, a forward pipe 18 as a forward path portion, and a return pipe 20 as a return path portion. The condenser 16, the forward pipe 18, the battery cooler 14, and the return pipe 20 are annularly connected to constitute a fluid circulation circuit 26 through which a refrigerant as working fluid of the device temperature adjusting apparatus 10 circulates.

In other words, the fluid circulation circuit 26 is a heat pipe which evaporates and condenses a refrigerant for heat transfer. The fluid circulation circuit 26 constitutes a loop type thermosiphon (i.e., thermosiphon circuit) where a flow path through which a gaseous refrigerant flows and a flow path through which a liquid refrigerant flows are separated from each other. FIG. 1 shows a cross section of the battery cooler 14 and portions of the pipes 18 and 20 connecting to the battery cooler 14. Arrows DR1 and DR2 shown in FIGS. 1 and 2 each indicate a direction of the vehicle 90 on which the device temperature adjusting apparatus 10 is mounted. Specifically, the arrow DR1 indicates a vehicle up-down direction DR1, while the arrow DR2 indicates a vehicle front-rear direction DR2.

A refrigerant is sealed and filled in the fluid circulation circuit 26. The inside of the fluid circulation circuit 26 is filled with the refrigerant. The refrigerant circulates through the fluid circulation circuit 26. The device temperature adjusting apparatus 10 controls the temperature of the battery 12 by a phase change of the refrigerant between liquid phase and gas phase. More specifically, the battery 12 is cooled by a phase change of the refrigerant.

For example, the refrigerant filled in the fluid circulation circuit 26 is a fluorocarbon refrigerant such as HFO-1234yf and HFC-134a.

As shown in FIGS. 1 and 2, the battery cooler 14 of the device temperature adjusting apparatus 10 is a heat absorbing portion which causes the refrigerant to absorb heat from the battery 12. In other words, the battery cooler 14 cools the battery 12 by heat transfer from the battery 12 to the refrigerant. For example, the battery cooler 14 is made of metal having high heat conductivity.

More specifically, a cooler chamber 14a which accumulates a liquid phase refrigerant is formed inside the battery cooler 14. The battery cooler 14 evaporates the refrigerant inside the cooler chamber 14a by causing the refrigerant to absorb heat from the battery 12.

The battery 12 cooled by the battery cooler 14 includes the plurality of battery cells 121 electrically connected in series. The plurality of battery cells 121 are stacked in a battery stacking direction DRb. The battery stacking direction DRb is horizontal in a vehicle horizontal state where the vehicle 90 is horizontally disposed.

According to the present embodiment, the battery 12 is disposed under a floor of the vehicle 90. Accordingly, the battery cooler 14 is also disposed under the floor of the vehicle 90. It is confirmed herein that FIG. 2 is a schematic diagram, and does not show specific connection portions of the respective pipes 18 and 20 with each of the battery cooler 14 and the condenser 16.

For example, the battery cooler 14 has a rectangular parallelepiped box shape, and extends in the battery stacking direction DRb. In addition, the battery cooler 14 has an upper surface portion 141 including an upper surface 141a of the battery cooler 14. Specifically, an upper inner wall surface 141b forming the upper side of the cooler chamber 14a is provided on the side opposite to the upper surface 141a side of the upper surface portion 141.

The filling amount of the refrigerant filled into the fluid circulation circuit 26 is an amount sufficient for filling the cooler chamber 14a in a liquid phase state in the vehicle horizontal condition when the liquid phase refrigerant accumulated in the cooler chamber 14a does not contain air bubbles produced by boiling of the refrigerant or the like. Accordingly, the liquid level of the liquid phase refrigerant is formed both inside the forward pipe 18 and inside the return pipe 20, and is positioned above the upper inner wall surface 141b of the battery cooler 14. In FIG. 1, a liquid level position SF1 of the liquid phase refrigerant inside the forward pipe 18 is indicated by a broken line SF1, while a liquid level position SF2 of the liquid phase refrigerant inside the return pipe 20 is indicated by a broken line SF2.

The plurality of battery cells 121 are each disposed in a line on the upper surface 141a of the battery cooler 14. Each of the plurality of battery cells 121 is connected to the upper surface portion 141 in such a condition as to allow heat conduction to the upper surface portion 141 of the battery cooler 14. In this arrangement, the upper surface 141a of the battery cooler 14 functions as a battery cooling surface for cooling the battery 12, while the upper surface portion 141 of the battery cooler 14 functions as a cooling surface forming portion which forms the battery cooling surface.

An inlet port 14b and an outlet port 14c are formed in the battery cooler 14. The inlet port 14b communicatively connects a forward flow passage 18a formed inside the forward pipe 18 to the inside of the battery cooler 14 (i.e., cooler chamber 14a). Accordingly, when the refrigerant circulates through the fluid circulation circuit 26, the refrigerant in the forward flow passage 18a flows into the cooler chamber 14a via the inlet port 14b of the battery cooler 14. The forward flow passage 18a is a refrigerant flow path through which a refrigerant flows from the condenser 16 to the battery cooler 14. For example, the inlet port 14b of the battery cooler 14 is provided at an end of the battery cooler 14 on one side in the battery stacking direction DRb.

The outlet port 14c of the battery cooler 14 communicatively connects a return flow passage 20a formed inside the return pipe 20 to the inside of the battery cooler 14. Accordingly, when the refrigerant circulates through the fluid circulation circuit 26, the refrigerant in the cooler chamber 14a flows out to the return flow passage 20a via the outlet port 14c of the battery cooler 14. The return flow passage 20a is a refrigerant flow path through which a refrigerant flows from the battery cooler 14 to the condenser 16. For example, the outlet port 14c of the battery cooler 14 is provided at an end of the battery cooler 14 on the other side in the battery stacking direction DRb. The battery cooler 14 has a not-shown structure for allowing a gas phase refrigerant in the cooler chamber 14a to flow out exclusively from the outlet port 14c as one of a pair of the inlet port 14b and the outlet port 14c.

The condenser 16 of the device temperature adjusting apparatus 10 is a heat releasing portion which causes heat release from the refrigerant inside the condenser 16 to heat receiving fluid. More specifically, a gas phase refrigerant flows into the condenser 16 from the return pipe 20. The condenser 16 condenses the refrigerant by causing heat release from the refrigerant. In the present embodiment, the heat receiving fluid subjected to heat exchange with the refrigerant inside the condenser 16 is air as described below.

The condenser 16 is disposed above the battery cooler 14. The forward pipe 18 is connected to a lower portion of the condenser 16, while the return pipe 20 is connected to an upper portion of the condenser 16. In short, the forward pipe 18 is connected to the condenser 16 below the return pipe 20. Accordingly, the refrigerant condensed in the condenser 16, that is, the liquid phase refrigerant inside the condenser 16 flows from the inside of the condenser 16 to the forward flow passage 18a by gravity.

According to the device temperature adjusting apparatus 10 in FIG. 1 configured as described above, when the battery temperature increases by heat generated from the battery 12 during traveling of the vehicle, for example, the heat is transferred to the upper surface portion 141 of the battery cooler 14 via lower surfaces of the battery cells 121. The liquid phase refrigerant inside the battery cooler 14 therefore boils by the heat. Each of the battery cells 121 is cooled by latent heat of vaporization generated by boiling of the liquid phase refrigerant. The refrigerant boiled inside the battery cooler 14 gasifies and moves upward. Specifically, the gasified refrigerant (i.e., gas phase refrigerant) moves toward the condenser 16 via the return flow passage 20a. In this case, the gas phase refrigerant having flowed into the condenser 16 is cooled and liquefied at the condenser 16, and again flows into the battery cooler 14 via the forward pipe 18.

In short, with a start of a thermosiphoning phenomenon in the device temperature adjusting apparatus 10, the refrigerant circulates through the fluid circulation circuit 26 as indicated by arrows ARc. According to the device temperature adjusting apparatus 10, therefore, these operations are performed by natural circulation of the refrigerant sealed in the fluid circulation circuit 26 without requiring a drive device such as a compressor.

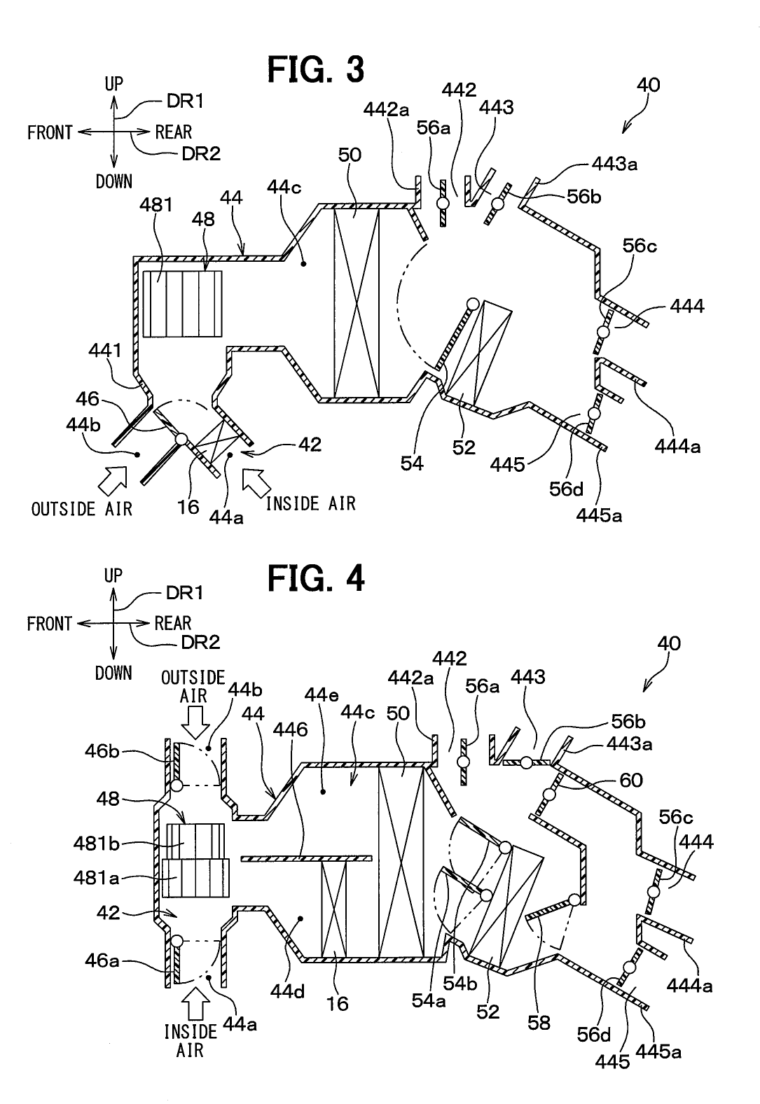

Similarly to an ordinary vehicle, the vehicle 90 of the present embodiment includes an air conditioning unit 40 which blows temperature-controlled air to the interior of the vehicle. As shown in FIG. 3, the condenser 16 of the device temperature adjusting apparatus 10 is disposed in an inside air circulation path 42 through which inside air circulates during vehicle interior air conditioning performed by the air conditioning unit 40. The state “inside air circulates” refers to a state that “substantially only inside air circulates”. The state that “substantially only inside air circulates” includes a state that a small amount of outside air is mixed. The small amount of the mixed outside air is an amount small enough to produce substantially no temperature change from a temperature in case of circulation of only the inside air even when the small amount of the outside air is mixed into the inside air.

For explaining an arrangement of the condenser 16, the air conditioning unit 40 shown in FIG. 3 will be herein described.

As shown in FIG. 3, the air conditioning unit 40 is substantially similar to an ordinary vehicle air-conditioning unit except the point that the condenser 16 is provided.

For example, the air conditioning unit 40 shown in FIG. 3 is disposed inside an instrument panel in a foremost part of the interior of the vehicle. The air conditioning unit 40 sucks one or both of the inside air which is the air in the interior of the vehicle, and the outside air which is the air outside the interior of the vehicle, and also blows out the sucked air to the interior of the vehicle after controlling the temperature of the sucked air. As shown in FIG. 3, the air conditioning unit 40 includes an air conditioning case 44, an inside/outside air switching door 46, a blower 48 as a blower, an evaporator 50, an air heater 52, an air mixing door 54, and a plurality of air outlet switching doors 56a to 56d, and others. For example, each of the air outlet switching doors 56a to 56d is constituted by a butterfly door.

The air conditioning case 44 forms a housing of the air conditioning unit 40. Air introduction ports 44a and 44b are formed on one side of the air conditioning case 44, while a plurality of air outlet ports through which air flows toward the interior of the vehicle are formed on the other side. An air flow path 44c is formed inside the air conditioning case 44. The air flow path 44c directs blown air from the air introduction ports 44a and 44b toward the air outlet ports.

The air conditioning case 44 also includes an air suction portion 441, which has the two air introduction ports 44a and 44b, on the upstream side (i.e., one side) of the air conditioning case 44. One of the two air introduction ports 44a and 44b constitutes the inside air introduction port 44a through which inside air is sucked, while the other constitutes the outside air introduction port 44b through which outside air is sucked. Accordingly, the air conditioning unit 40 sucks inside air from the inside air introduction port 44a, and sucks outside air from the outside air introduction port 44b.

The inside/outside air switching door 46 is an opening/closing device which increases and decreases the degree of opening of the inside air introduction port 44a, and the degree of opening of the outside air introduction port 44b. The inside/outside air switching door 46 rotates inside the air suction portion 441, and is driven by an actuator such as a servo motor. More specifically, the inside/outside air switching door 46 rotates in such a manner that opening of one of the inside air introduction port 44a and the outside air introduction port 44b decreases as opening of the other increases, thereby controlling a flow ratio of inside air to outside air each flowing into the air suction portion 441. The degree of opening of the inside air introduction port 44a is a level of opening of the inside air introduction port 44a, while the degree of opening of the outside air introduction port 44b is a level of opening of the outside air introduction port 44b.

For example, the inside/outside air switching door 46 switches a mode of the air conditioning unit 40 between an inside air mode for introducing exclusively inside air into the air conditioning unit 40, and an outside air mode for introducing exclusively outside air into the air conditioning unit 40. In the inside air mode, the inside/outside air switching door 46 opens the inside air introduction port 44a and closes the outside air introduction port 44b. In short, the inside/outside air switching door 46 sets the degree of opening of the inside air introduction port 44a to 100%, and the degree of opening of the outside air introduction port 44b to 0%.

In the outside air mode, the inside/outside air switching door 46 closes the inside air introduction port 44a almost completely, and opens the outside air introduction port 44b. In short, the inside/outside air switching door 46 sets the degree of opening of the inside air introduction port 44a close to 0%, and the degree of opening of the outside air introduction port 44b to substantially 100%. Accordingly, in the outside air mode, the air conditioning unit 40 of the present embodiment comes into a semi-inside air introduction state where inside air is also introduced into the air conditioning unit 40 together with outside air.

In this manner, the air conditioning unit 40 provided with the inside/outside air switching door 46 can switch between the inside air mode and the outside air mode.

Each of the inside air introduction port 44a and the outside air introduction port 44b has a short duct shape. The inside air introduction port 44a is an introduction port through which inside air passes during interior vehicle air conditioning. Accordingly, the inside air introduction port 44a is included in the inside air circulation path 42. The condenser 16 of the device temperature adjusting apparatus 10 is disposed in the inside air introduction port 44a. Accordingly, when the inside air introduction port 44a is opened, inside air flowing into the inside air introduction port 44a exchanges heat with the refrigerant inside the condenser 16 at the condenser 16, and is sucked into the blower 48 after the heat exchange.

The condenser 16 is disposed on the airflow upstream side with respect to the inside/outside air switching door 46.

The blower 48 directs air having flowed into the air suction portion 441 toward the evaporator 50, and directs the air having passed through the evaporator 50 to the interior of the vehicle. In short, the blower 48 directs air from the inside of the air conditioning unit 40 to the interior of the vehicle. For producing this airflow, the blower 48 includes an impeller 481, which is a centrifugal fan, and a not-shown motor which rotates the impeller 481.

The impeller 481 of the blower 48 is disposed on the downstream side of the air suction portion 441 and on the upstream side of the evaporator 50 in the airflow inside the air conditioning case 44.

The evaporator 50 is disposed on the airflow downstream side with respect to the impeller 481 of the blower 48 inside the air conditioning case 44. The evaporator 50 is a heat exchanger for air cooling. The evaporator 50 constitutes a part of a not-shown vapor compression refrigeration cycle. The evaporator 50 achieves heat exchange between a heat exchange medium circulating in the refrigeration cycle and the blown air fed from the blower 48, and evaporates and gasifies the heat exchange medium and cools the blown air by the heat exchange.

The air heater 52 is disposed on the airflow downstream side with respect to the evaporator 50 inside the air conditioning case 44. The air heater 52 is a heater core which heats air passing through the air heater 52 by heat exchange between the air and engine cooling water for engine cooling.

The air heater 52 is so disposed as to cross a part of the air flow path 44c on the airflow downstream side with respect to the evaporator 50 inside the air conditioning case 44.

The air mixing door 54 is disposed on the airflow upstream side with respect to the air heater 52 and on the airflow downstream side with respect to the evaporator 50. The air mixing door 54 driven by an actuator such as a servo motor changes the blowing temperature of conditioned air blown from the respective air outlet ports to the interior of the vehicle. In other words, the air mixing door 54 controls an air amount ratio of cold air passing through the evaporator 50 and bypassing the air heater 52 to warm air passing through the evaporator 50 and then passing through the air heater 52 in accordance with a rotation position of the air mixing door 54.

The air conditioning case 44 has a defroster opening 442, a face opening 443, a front seat foot opening 444, and a rear seat foot opening 445. The respective openings 442, 443, 444, 445 are disposed at a portion on the most downstream side in the airflow inside the air conditioning case 44.

A defroster duct 442a is connected to the defroster opening 442. A defroster door 56a is provided at the defroster opening 442. The defroster door 56a opens and closes the defroster opening 442. The defroster opening 442 is an opening through which air (chiefly warm air, for example) is blown toward an inner surface of a front window of the vehicle 90 via the defroster duct 442a when the defroster opening 442 is opened by the defroster door 56a.

A face duct 443a is connected to the face opening 443. A face door 56b is provided at the face opening 443. The face door 56b opens and closes the face opening 443. The face opening 443 is an opening through which air (chiefly cold air, for example) is blown toward a head and chest part of a front seat occupant via the face duct 443a when the face opening 443 is opened by the face door 56b.

A front seat foot duct 444a is connected to the front seat foot opening 444. A front seat foot door 56c is provided at the front seat foot opening 444. The front seat foot door 56c opens and closes the front seat foot opening 444. The front seat foot opening 444 is an opening through which air (chiefly warm air, for example) is blown toward a foot part of a front seat occupant via the front seat foot duct 444a when the front seat foot opening 444 is opened by the front seat foot door 56c.

A rear seat foot duct 445a is connected to the rear seat foot opening 445. A rear seat foot door 56d is provided at the rear seat foot opening 445. The rear seat foot door 56d opens and closes the rear seat foot opening 445. The rear seat foot opening 445 is an opening through which air (chiefly warm air, for example) is blown toward a foot part of a rear seat occupant via the rear seat foot duct 445a when the rear seat foot opening 445 is opened by the rear seat foot door 56d.

An air outlet port mode of the air conditioning unit 40 is switched in accordance with opening and closing operations of the respective air outlet switching doors 56a to 56d. Examples of the air outlet port mode include a face mode, a bi-level mode, a foot mode, a foot-defroster mode, and a defroster mode.

According to the present embodiment, as described above, the condenser 16 of the device temperature adjusting apparatus 10 is disposed in the inside air circulation path 42 through which inside air circulates during vehicle interior air conditioning performed by the air conditioning unit 40. More specifically, the condenser 16 is disposed in the inside air introduction port 44a of the air conditioning unit 40 in the inside air circulation path 42.

Cold air cooled in the interior of the vehicle passes through the inside air introduction port 44a in the summertime, while heated warm air passes through the inside air introduction port 44a in the wintertime. In a comparative example in which a cooling device is disposed in a front part of a vehicle, however, working fluid corresponding to a refrigerant is always cooled by airflow generated during traveling as outside air. In case of the cooling device which cools working fluid by using airflow generated during traveling like the cooling device of the comparative example, cooling performance of the cooling device deteriorates by a drop of heat release performance of the heat releasing portion at a higher outside air temperature in the summertime, for example. On the contrary, a target device corresponding to a cooling target (e.g., battery, semiconductor switching element) is cooled more than necessary at a lower outside air temperature in the wintertime. In short, the target device is excessively cooled. In contrast, according to the present embodiment, therefore, cold air (i.e., inside air) having a lower temperature than the temperature of cold air of the cooling device of the comparative example can be supplied to the condenser 16 in the summertime. Moreover, according to the present embodiment, warm air having a higher temperature than the temperature of warm air of the cooling device of the comparative example can be supplied to the condenser 16 in the wintertime. Accordingly, cooling performance of the device temperature adjusting apparatus 10 in the summertime can improve, and excessive cooling of the battery 12 in the wintertime can decrease.

The operation performed in the summertime will be described in detail. Cold air, which is inside air passing through the inside air introduction port 44a, flows to the condenser 16. In this case, a temperature difference between the battery cooler 14 and the condenser 16 becomes large in the device temperature adjusting apparatus 10 of the present embodiment in comparison with the cooling device of the comparative example. A circulation amount of the refrigerant in the fluid circulation circuit 26 is substantially proportional to the temperature difference. Accordingly, cooling performance of the device temperature adjusting apparatus 10 improves as the circulation amount of the refrigerant increases.

Incidentally, the mode of the air conditioning unit 40 is expected to be switched to the outside air mode in the summertime. In this case, the air conditioning unit 40 of the present embodiment comes into the semi-inside air introduction state described above in the outside air mode for the purpose of energy saving similarly to air conditioning units available in recent years. Accordingly, the air conditioning unit 40 has such a structure that constantly directs wind (i.e., inside air) toward the inside air introduction port 44a during air conditioning operation by the air conditioning unit 40.

The operation performed in the wintertime will be described in detail. Warm air, which is inside air passing through the inside air introduction port 44a, flows toward the condenser 16. In this case, the temperature difference between the battery cooler 14 and the condenser 16 becomes small in the device temperature adjusting apparatus 10 of the present embodiment in comparison with the cooling device of the comparative example. Alternatively, a reverse temperature difference, i.e., a state that the temperature of the condenser 16 becomes higher than the temperature of the battery cooler 14, is produced. In this case, the circulation amount of the refrigerant decreases, or circulation of the refrigerant stops in the device temperature adjusting apparatus 10 of the present embodiment unlike the cooling device of the comparative example. Accordingly, excessive cooling of the battery 12 can decrease in the wintertime.

According to the present embodiment, air blowing to the condenser 16 is achieved by the blower 48 of the air conditioning unit 40. Accordingly, as an advantageous effect produced by this configuration, the necessity of providing a dedicated blower for blowing air to the condenser 16 can be eliminated.

According to the present embodiment, the condenser 16 is disposed in the inside air introduction port 44a of the air conditioning unit 40. In this case, the condenser 16 is disposed within an occupied space of the air conditioning unit 40. Accordingly, a mounting space for the condenser 16 need not be prepared. In short, mountability of the device temperature adjusting apparatus 10 easily improves.

According to the cooling device of the comparative example, the heat releasing portion corresponding to the condenser 16 is disposed in the front part of the vehicle. However, the condenser 16 of the device temperature adjusting apparatus 10 of the present embodiment is disposed in the inside air introduction port 44a of the air conditioning unit 40. The battery 12 is often disposed under the floor or under the trunk room of the vehicle 90. In this case, the distance between the condenser 16 and the battery cooler 14 can become shorter in the device temperature adjusting apparatus 10 of the present embodiment than that in the cooling device of the comparative example. Accordingly, reduction of deterioration of cooling performance caused by pressure losses and heat transfer in the respective pipes 18 and 20 is achievable, for example.

In a scene where cooling of the battery 12 and heating operation of the air conditioning unit 40 are both desired in an intermediate season such as spring or autumn, waste heat of the battery 12 is released to inside air at the condenser 16. Accordingly, the waste heat of the battery 12 can be utilized for heating of the interior of the vehicle.

According to the present embodiment, the plurality of battery cells 121 are disposed in a line on the upper surface 141a of the battery cooler 14. In other words, the respective battery cells 121 of the battery 12 are carried on the upper surface portion 141 of the battery cooler 14. Assuming herein a comparative example where the respective battery cells 121 come into contact with not the upper surface 141a but the side surface of the battery cooler 14, a certain level of pressing load (e.g., restraining force) for promoting heat transfer between the battery cooler 14 and the battery cells 121 is needed between the battery cooler 14 and the battery cells 121 in the comparative example.

However, according to the device temperature adjusting apparatus 10 of the present embodiment as described above, the respective battery cells 121 are carried on the battery cooler 14. In other words, the battery cooler 14 is disposed not on the side surfaces but on the lower surfaces of the battery cells 121. In this case, a contact load can be securely produced between the battery cells 121 and the battery cooler 14 by the own weight of the battery cells 121. Accordingly, for cooling the battery 12, a lower surface cooling method which positions the battery cooler 14 on the lower side of the battery 12 as in the present embodiment is more advantageous than the arrangement method of the comparative example.

### Second Embodiment

A second embodiment will now be described. In the present embodiment, points different from the above-described first embodiment will be chiefly described. Description of parts identical or equivalent to corresponding parts in the above embodiment will be omitted or simplified. This omission or simplification is also applied to a third embodiment described below.

According to the present embodiment, the arrangement of the air conditioning unit 40 and the condenser 16 is different from the corresponding arrangement of the above-described first embodiment as shown in FIG. 4. Other points of the present embodiment are similar to corresponding points of the first embodiment.

The air conditioning unit 40 of the present embodiment has an inside/outside air two-layer structure where an outside air passage 44e through which outside air flows, and an inside air passage 44d through which inside air flows are formed in parallel to each other. In other words, the inside air passage 44d and the outside air passage 44e are formed inside the air conditioning case 44 as a part of the air flow path 44c.

More specifically, the air conditioning case 44 includes a partition wall 446 which vertically partitions the air flow path 44c on the airflow upstream side with respect to the evaporator 50. On the airflow upstream side of the evaporator 50, the inside air passage 44d is formed below the partition wall 446, and the outside air passage 44e is formed above the partition wall 446.

The inside air passage 44d is a passage through which inside air passes during vehicle interior air conditioning, and is therefore included in the inside air circulation path 42. The condenser 16 of the device temperature adjusting apparatus 10 is disposed in the inside air passage 44d. Accordingly, inside air flows to the inside air passage 44d when the inside air introduction port 44a is opened. The inside air flowing through the inside air passage 44d exchanges heat with the refrigerant inside the condenser 16 at the condenser 16, and flows to the evaporator 50 after the heat exchange.

The air conditioning unit 40 of the present embodiment includes an inside air introduction port door 46a and an outside air introduction port door 46b instead of the inside/outside air switching door 46 of the first embodiment. The inside air introduction port door 46a opens and closes the inside air introduction port 44a, while the outside air introduction port door 46b opens and closes the outside air introduction port 44b. According to the present embodiment, the degree of opening of the inside air introduction port 44a and the degree of opening of the outside air introduction port 44b are controlled by operations of the respective introduction port doors 46a and 46b in either the inside air mode or the outside air mode in a manner similar to the manner of the first embodiment.

The blower 48 of the present embodiment includes an inside air impeller 481a and an outside air impeller 481b instead of the impeller 481 of the first embodiment. Each of the inside air impeller 481a and the outside air impeller 481b is a centrifugal fan.

In the airflow inside the air conditioning case 44, the inside air impeller 481a is disposed on the downstream side of the inside air introduction port 44a and on the upstream side of the inside air passage 44d. The outside air impeller 481b is disposed on the downstream side of the outside air introduction port 44b and on the upstream side of the outside air passage 44e. Accordingly, the inside air impeller 481a directs inside air sucked from the inside air introduction port 44a toward the inside air passage 44d in accordance with rotation of the inside air impeller 481a. The outside air impeller 481b directs outside air sucked from the outside air introduction port 44b toward the outside air passage 44e in accordance with rotation of the outside air impeller 481b. The blower 48 is configured to prevent mixture between the inside air blown by the inside air impeller 481a and the outside air blown by the outside air impeller 481b.

The air conditioning unit 40 of the present embodiment has a first air mixing door 54a and a second air mixing door 54b instead of the air mixing door 54 of the first embodiment. Each of the first air mixing door 54a and the second air mixing door 54b rotates. The first air mixing door 54a and the second air mixing door 54b control the air amount ratio of cold air to warm air by rotation of both the first air mixing door 54a and the second air mixing door 54b similarly to the air mixing door 54 of the first embodiment.

The air conditioning unit 40 of the present embodiment includes a first air flow path change door 58 and a second air flow path change door 60 disposed on the airflow downstream side with respect to the evaporator 50. Rotation of the two air flow path change doors 58 and 60 changes the path of airflow on the airflow downstream side of the evaporator 50.

According to the present embodiment, effects similar to those of the first embodiment described above can be produced by common configurations of the present embodiment and the first embodiment.

According to the present embodiment, the condenser 16 of the device temperature adjusting apparatus 10 is disposed in the inside air passage 44d of the air conditioning unit 40. This configuration therefore can produce effects similar to the effects produced when the condenser 16 is disposed in the inside air introduction port 44a of the air conditioning unit 40 as in the first embodiment.

### Third Embodiment

A third embodiment will now be described. In the present embodiment, points different from the above-described first embodiment will be chiefly described.

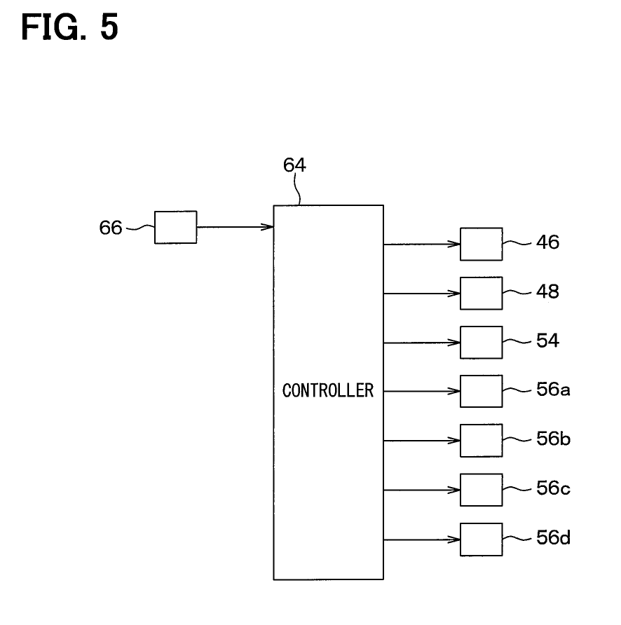

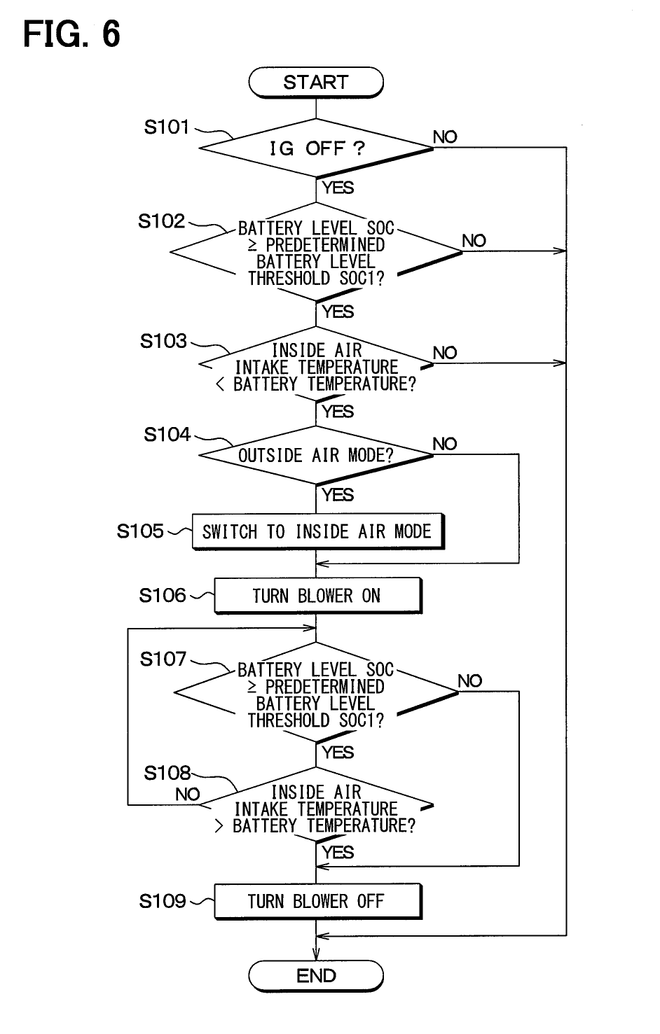

According to the present embodiment, the device temperature adjusting apparatus 10 includes a controller 64 shown in FIG. 5. The controller 64 executes a control process in FIG. 6. The present embodiment is different from the first embodiment in this point. Other points of the present embodiment are similar to corresponding points of the first embodiment. For example, the air conditioning unit 40 of the present embodiment is configured as shown in FIG. 3.

For example, the controller 64 in FIG. 5 constitutes one functional unit of an air conditioning control device which executes air conditioning control performed by the air conditioning unit 40. The air conditioning control device is an electronic control device which includes a known microcomputer including a central processing unit (CPU), a read-only memory (ROM), a random-access memory (RAM), and the like, and peripheral circuits of the microcomputer. Accordingly, the controller 64 executes a computer program stored in a non-transitional tangible storage medium such as a semiconductor memory. This computer program is executed to perform a method corresponding to the computer program.

The controller 64 of the present embodiment outputs various control signals to each actuator of the air conditioning unit 40. For example, the controller 64 can control respective operations of the inside/outside air switching door 46, the blower 48, the air mixing door 54, and the plurality of air outlet switching doors 56a to 56d by outputting control signals.

The control process in FIG. 6 will now be described. FIG. 6 is a flowchart showing the control process executed by the controller 64 according to the present embodiment. The controller 64 cyclically and repeatedly executes the control process in FIG. 6.

As shown in FIG. 6, the controller 64 initially determines in step S101 whether or not the operation of the vehicle 90 has ended. The end of the operation of the vehicle 90 is determined based on on/off of an ignition switch 66 (see FIG. 5). Specifically, when the ignition switch 66 is on, it is determined that the operation of the vehicle 90 has not ended. When the ignition switch 66 is turned off, it is determined that the operation of the vehicle 90 has ended.

When it is determined in step S101 in FIG. 6 that the operation of the vehicle 90 has ended, the process proceeds to step S102. When it is determined that the operation of the vehicle 90 has not ended yet, processing of step S101 is repeated. In other words, processing of step S102 and thereafter is executed after an end of the operation of the vehicle 90.

In step S102, the controller 64 acquires a battery level SOC of the battery 12. After acquisition of this level, the controller 64 determines whether or not the battery level SOC is equal to or higher than a predetermined battery level threshold SOC1. The battery level threshold value SOC1 is experimentally determined in advance to check whether the battery level SOC is sufficient for operating the blower 48 in step S106 described below.

When it is determined in step S102 that the battery level SOC is equal to or higher than the battery level threshold SOC1, the process proceeds to step S103. When it is determined that the battery level SOC is lower than the battery level threshold SOC1, the control process in FIG. 6 is again started from step S101.

In step S103, the controller 64 acquires each of an inside air temperature which is the temperature of inside air, and a battery temperature which is the temperature of the battery 12. More specifically, the controller 64 acquires the temperature of inside air sucked into the inside air introduction port 44a, that is, an inside air intake temperature as the inside air temperature. For example, the inside air intake temperature is detected by an inside air temperature sensor disposed on the airflow upstream side of the condenser 16 in the inside air introduction port 44a. The controller 64 acquires the inside air intake temperature based on a detection signal of the inside air temperature sensor. The controller 64 may temporarily blow a breeze to the blower 48 as required for temperature detection by the inside air temperature sensor.

The controller 64 further acquires a maximum value in temperatures of the respective battery cells 121 (i.e., battery cell temperatures) as the battery temperature, for example. Each of the battery cell temperatures is detected by a battery cell temperature sensor provided for each of the battery cells 121. The controller 64 acquires the respective battery cell temperatures from detection signals of the battery cell temperature sensors.

After acquiring the battery temperature and the inside air temperature, the controller 64 in step S103 determines whether or not the battery temperature is higher than the inside air temperature.

When it is determined in step S103 that the battery temperature is higher than the inside air temperature, the process proceeds to step S104. When it is determined that the battery temperature is equal to or lower than the inside air temperature, the control process in FIG. 6 is again started from step S101.

In step S104, the controller 64 determines whether or not the air conditioning unit 40 is in the outside air mode. More specifically, it is determined whether the air conditioning unit 40 is in the outside air mode or the inside air mode based on a door rotation position of the inside/outside air switching door 46.

When it is determined in step S104 that the air conditioning unit 40 is in the outside air mode, the process proceeds to step S105. When it is determined that the air conditioning unit 40 is not in the outside air mode, the process proceeds to step S106 based on a state that the air conditioning unit 40 has been already in the inside air mode.

In step S105, the controller 64 switches the mode of the air conditioning unit 40 to the inside air mode by operating the inside/outside air switching door 46. After completion of step S105, the process proceeds to step S106.

In step S106, the controller 64 operates the blower 48. Specifically, the blower 48 is turned on. The on-state of the blower 48 continues until the blower 48 is turned off in step S109 described below. For example, the rotation speed of the blower 48 at this time is experimentally set in advance to such a speed for generating an air blowing amount sufficient for condensing the refrigerant at the condenser 16, and to a lowest possible rotation speed.

Blown air may be blown from any of the openings 442 to 445 during air blowing from the blower 48 started in step S106. According to the present embodiment, the controller 64 sets the air outlet port mode of the air conditioning unit 40 exclusively to the foot mode where air is blown exclusively from the foot openings 444 and 445 of the plurality of openings 442 to 445 by operating the respective air outlet switching doors 56a to 56d. After completion of step S106, the process proceeds to step S107.

In step S107, the controller 64 acquires the battery level SOC of the battery 12. The battery level SOC is detected and acquired similarly to step S102, but the detection time is different from the detection time in step S102.

Subsequently, the controller 64 determines whether or not the battery level SOC is equal to or higher than the predetermined battery level threshold SOC1 similarly to step S102 described above.

When it is determined in step S107 that the battery level SOC is equal to or higher than the battery level threshold SOC1, the process proceeds to step S108. When it is determined that the battery level SOC is lower than the battery level threshold SOC1, the process proceeds to step S109.

In step S108, the controller 64 acquires each of the inside air temperature and the battery temperature. The inside air temperature and the battery temperature are detected and acquired similarly to step S103, but the detection time is different from the detection time in step S103.

In step S108, the controller 64 having acquired the battery temperature and the inside air temperature determines whether or not the battery temperature has become lower than the inside air temperature.

When it is determined in step S108 that the battery temperature has become lower than the inside air temperature, the process proceeds to step S109. When it is determined that the battery temperature is equal to or higher than the inside air temperature, the process proceeds to step S107.

In step S109, the controller 64 stops the blower 48. Specifically, the blower 48 is turned off.

In this manner, while monitoring the battery level SOC, the controller 64 switches the mode of the air conditioning unit 40 to the inside air mode and operates the blower 48 when the battery temperature is higher than the inside air temperature after an end of the operation of the vehicle 90. Specifically, the controller 64 causes circulation of inside air through the inside air circulation path 42 (more specifically, inside air introduction port 44a) by the operation of the blower 48.

The battery 12 therefore can be cooled by cold air remaining in the interior of the vehicle (more specifically, inside air having temperature lower than temperature of battery 12) after the end of the operation of the vehicle 90. Accordingly, an average temperature of the battery 12 of the vehicle during parking can decrease, for example, wherefore deterioration prevention and life elongation of the battery 12 are achievable.

The foregoing processing performed in the respective steps in FIG. 6 constitutes a function section for implementing the corresponding function.

In addition, effects similar to the effects of the first embodiment can be produced in the present embodiment by the configurations common to the present embodiment and the first embodiment described above.

The present embodiment presented as a modified example based on the first embodiment can be combined with the second embodiment described above as well.

### Other Embodiments

(1) According to the respective embodiments described above, the target device to be cooled by the device temperature adjusting apparatus 10 is the secondary battery 12 as shown in FIG. 1. However, the target device is not limited to any particular device. For example, the target device may be an electronic device other than the secondary battery 12, such as a motor, an inverter, and a charger, or may be a simple heating element. In addition, the target device is not limited to an in-vehicle device, but may be a device which requires stationary cooling, such as a base station.

(2) According to the respective embodiments described above, the air heater 52 is a heater core. However, the air heater 52 may be an indoor condenser constituting a part of a refrigeration cycle.

(3) According to the respective embodiments described above, the condenser 16 of the device temperature adjusting apparatus 10 is disposed on the airflow upstream side with respect to the evaporator 50. However, this arrangement is presented only by way of example. For example, the condenser 16 may be disposed on the airflow downstream side with respect to the evaporator 50 as long as the condenser 16 is located in the inside air circulation path 42.

(4) According to the respective embodiments described above, the inside air circulation path 42 includes the inside air introduction port 44a and the inside air passage 44d of the air conditioning unit 40. However, the inside air circulation path 42 may include a portion other than the air conditioning unit 40. For example, when an air flow duct connected to the inside air introduction port 44a to guide inside air to the inside air introduction port 44a is provided outside the air conditioning unit 40, the inside air circulation path 42 includes a duct passage inside the air flow duct. The condenser 16 of the device temperature adjusting apparatus 10 may be disposed in the duct passage. In short, the condenser 16 may be disposed anywhere in the inside air circulation path 42 either inside or outside the air conditioning unit 40.

(5) According to the third embodiment described above, the battery temperature compared with the inside air temperature in steps S102 and S108 in FIG. 6 is the maximum value in the temperatures of the respective battery cells 121, for example. However, this value is presented by way of example. For example, the average value of the temperatures of the respective battery cells 121 may be calculated as the battery temperature.

(6) According to the third embodiment described above, the inside air intake temperature is acquired as the inside air temperature in steps S102 and S108 in FIG. 6. However, instead of the inside air intake temperature, a room temperature detected at any position in the interior of the vehicle may be acquired as the inside air temperature.

(7) According to the respective embodiments described above, the air conditioning unit 40 is a front air conditioning unit disposed in the foremost part of the interior of the vehicle, for example. However, this configuration is presented by way of example. The air conditioning unit 40 where the condenser 16 of the device temperature adjusting apparatus 10 is disposed may be a rear air conditioning unit included in a dual air conditioner, for example.

(8) According to the respective embodiments described above, the forward pipe 18 is provided as the forward path portion of the device temperature adjusting apparatus 10. However, the forward path portion may be a component other than a piping member. For example, when a hole formed in a block-shaped object is provided as the forward flow passage 18a, a portion included in the block-shaped object and forming the forward flow passage 18a corresponds to the forward path portion. This configuration is also applicable to the return pipe 20.

(9) According to the respective embodiments described above, the one condenser 16 is provided as shown in FIG. 1. However, a plurality of the condensers 16 may be provided. When a plurality of the condensers 16 are provided as described herein, any one or all of a heat exchanger performing heat exchange between the air and the refrigerant in the fluid circulation circuit 26 as in the respective embodiments described above, a refrigerant-refrigerant heat exchanger, and a chiller may be included in the plurality of condensers 16, for example. The refrigerant-refrigerant heat exchanger is a heat exchange which constitutes a part of a refrigeration cycle different from the refrigeration cycle to which the evaporator 50 (see FIG. 3) belongs, and cools the refrigerant in the fluid circulation circuit 26 by evaporating a heat exchange medium circulating in the refrigeration cycle. The chiller is a cooling device which cools the refrigerant in the fluid circulation circuit 26 by using a liquid medium such as cooling water.

(10) According to the respective embodiments described above, the refrigerant filled in the fluid circulation circuit 26 is a fluorocarbon refrigerant, for example. However, the refrigerant inside the fluid circulation circuit 26 is not limited to a fluorocarbon refrigerant. For example, other refrigerants such as propane and CO2, or other mediums each achieving a phase change may be used as the refrigerant filled into the fluid circulation circuit 26.

(11) According to the respective embodiments described above, the device temperature adjusting apparatus 10 controls the temperature of the battery 12 by cooling the battery 12. However, in addition to this cooling function, the device temperature adjusting apparatus 10 may have a heating function for heating the battery 12.

(12) According to the first embodiment described above, the air conditioning case 44 of the air conditioning unit 40 is configured such that the air flow path 44c extends approximately in the vehicle front-rear direction DR2 as shown in FIG. 3. However, this configuration is presented by way of example. The shape of the air conditioning case 44 and the arrangement of respective devices inside the air conditioning case 44 are determined according to a specific vehicle on which the air conditioning unit 40 is mounted. This point is also applicable to the air conditioning unit 40 of the second embodiment shown in FIG. 4.

(13) According to the respective embodiments described above, the air conditioning case 44 of the air conditioning unit 40 has the two foot openings 444 and 445. However, the air conditioning case 44 not having one of the two foot openings 444 and 445 may be adopted.

(14) According to the third embodiment described above, processing in the respective steps shown in the flowchart in FIG. 6 is performed by a computer program. However, this processing may be constituted by hard logic.

(15) According to the third embodiment described above, the controller 64 is configured as one functional unit of the air conditioning control device of the air conditioning unit 40, for example. However, the controller 64 may constitute a control device different from the air conditioning control device.

(16) According to the respective embodiments described above, the condenser 16 of the device temperature adjusting apparatus 10 is disposed in the inside air circulation path 42 of the air conditioning unit 40 shown in FIGS. 3 and 4. However, the condenser 16 may be disposed in the inside air circulation path 42 provided in an air conditioning unit other than the air conditioning unit 40.

For example, the condenser 16 may be disposed in the inside air circulation path 42 provided in a rear seat cooler. The rear seat cooler is an air conditioning unit for air conditioning around a rear seat in the interior of the vehicle. The rear seat cooler is disposed on a side trim of the vehicle and includes the inside air introduction port 44a, but does not include the outside air introduction port 44b.

Alternatively, the condenser 16 may be disposed in the inside air circulation path 42 provided in a seat air conditioner. The seat air conditioner is an air conditioning unit which feeds air to vehicle seats disposed in the interior of the vehicle. The seat air conditioner includes the inside air introduction port 44a, but does not include the outside air introduction port 44b.

It should be noted that the present disclosure is not limited to the above-described embodiments, but includes various modified examples and modifications within the equivalent scope. The respective embodiments described herein are not embodiments unrelated to each other, and therefore can be appropriately combined unless such combinations are obviously inappropriate.

According to the respective embodiments described above, needless to say, elements constituting the respective embodiments are not necessarily essential unless clearly expressed as particularly essential, or considered as obviously essential in principle, for example. According to the respective embodiments described above, values such as numbers of the constituent elements, numerical values, quantities, and ranges in the embodiments are not limited to specific values unless clearly expressed as particularly essential, or considered as obviously limited to the specific values in principle, for example.

According to the respective embodiments described above, materials, shapes, positional relationships, or others of the constituent elements and the like described in the embodiments are not limited to specific materials, shapes, positional relationships, or others unless clearly expressed, or limited to the specific materials, shapes, positional relationships, or others in principle.

### CONCLUSION

According to a first aspect presented as a part or all of the respective embodiments described above, the heat releasing portion is disposed in the inside air circulation path through which the inside air circulates during vehicle interior air conditioning performed by the air conditioning unit that blows out temperature-controlled air to the interior of the vehicle.

According to a second aspect, the heat releasing portion is disposed in the inside air introduction port. Accordingly, similarly to the first aspect described above, cooling performance of the device temperature adjusting apparatus in the summertime can improve, and excessive cooling of the target device in the wintertime can decrease. Furthermore, air blowing to the heat releasing portion is performed by an air blowing function of the air conditioning unit, wherefore, as an advantageous effect, the necessity of providing a dedicated blower for blowing air to the heat releasing portion is eliminated.

Moreover, the heat releasing portion is disposed within the occupied space of the air conditioning unit. Accordingly, a mounting space for the heat releasing portion need not be prepared. In short, mountability of the device temperature adjusting apparatus easily improves.

In a scene where cooling of the target device by the device temperature adjusting apparatus and heating operation by the air conditioning unit are both performed, waste heat of the target device is released to inside air at the heat releasing portion. Accordingly, the waste heat of the target device can be utilized for heating of the interior of the vehicle.

According to a third aspect, the air conditioning unit has an inside/outside air two-layer structure where an outside air passage through which outside air flows, and an inside air passage through which inside air flows are formed in parallel to each other. The inside air passage is included in the inside air circulation path. The heat releasing portion is disposed in the inside air passage. Accordingly, effects similar to the effects of the second aspect can be produced by the air conditioning unit having the inside/outside air two-layer structure.

According to a fourth aspect, the controller operates the blower and causes the inside air to circulate through the inside air circulation path by the operation of the blower when the temperature of the battery is higher than the temperature of the inside air after an end of the operation of the vehicle. The battery therefore can be cooled by cold air remaining in the interior of the vehicle (more specifically, inside air having temperature lower than temperature of battery) after the end of the operation of the vehicle. Accordingly, an average temperature of the battery of the vehicle during parking decreases, for example, wherefore deterioration prevention and life elongation of the battery are achievable.

According to a fifth aspect, the controller switches the mode of the air conditioning unit to the inside air mode and operates the blower when the battery temperature is higher than the inside air temperature after an end of the operation of the vehicle. Accordingly, effects similar to the effects of the fourth aspect can be produced.

What is claimed is:

1. A device temperature adjusting apparatus mounted on a vehicle, and controlling a temperature of a target device by a phase transition of working fluid between a liquid phase and a gas phase, the working fluid circulating in the device temperature adjusting apparatus, the device temperature adjusting apparatus comprising:
a heat absorbing portion that evaporates the working fluid by causing the working fluid to absorb heat from the target device;
a heat releasing portion disposed above the heat absorbing portion, and condensing the working fluid by causing heat release from the working fluid;
a forward path portion that defines a forward flow passage through which the working fluid flows from the heat releasing portion to the heat absorbing portion; and
a return path portion that defines a return flow passage through which the working fluid flows from the heat absorbing portion to the heat releasing portion, wherein
the heat releasing portion is disposed in an inside air circulation path through which inside air circulates while vehicle interior air conditioning is performed by an air conditioning unit that blows out temperature-controlled air to an interior of the vehicle.

2. The device temperature adjusting apparatus according to claim 1, wherein
the air conditioning unit is configured to draw the inside air through an inside air introduction port formed in the air conditioning unit,
the inside air introduction port is included in the inside air circulation path, and
the heat releasing portion is located at the inside air introduction port.

3. The device temperature adjusting apparatus according to claim 1, wherein
the air conditioning unit has an inside-outside air two-layer structure in which an outside air passage through which outside air flows, and an inside air passage through which the inside air flows are formed in parallel to each other,
the inside air passage is included in the inside air circulation path, and
the heat releasing portion is disposed in the inside air passage.

4. The device temperature adjusting apparatus according to claim 1, further comprising a controller, wherein
the air conditioning unit includes a blower that sends air from an inside of the air conditioning unit to the interior of the vehicle,
the target device is a battery, and
the controller is configured to operate the blower to flow the inside air through the inside air circulation path when a temperature of the battery is higher than a temperature of the inside air after an end of an operation of the vehicle.

5. The device temperature adjusting apparatus according to claim 1, further comprising a controller, wherein
the air conditioning unit is configured to switch a mode of the air conditioning unit to an inside air mode in which the inside air is introduced into the air conditioning unit,
the air conditioning unit includes a blower that sends air from an inside of the air conditioning unit to the interior of the vehicle,
the target device is a battery, and
the controller is configured to switch the mode of the air conditioning unit to the inside air mode and actuate the blower when a temperature of the battery is higher than a temperature of the inside air after an end of an operation of the vehicle.

6. A device temperature adjusting apparatus mounted on a vehicle, and controlling a temperature of a target device by working fluid circulating in the device temperature adjusting apparatus, the device temperature adjusting apparatus comprising:
a target device cooler that evaporates the working fluid by causing the working fluid to absorb heat from the target device;
a condenser that is disposed above the heat absorbing portion and releases heat of the working fluid to an inside air in a vehicle interior to condense the working fluid;
a forward path portion that defines a forward flow passage through which the working fluid flows from the condenser to the target device cooler; and
a return path portion that defines a return flow passage through which the working fluid flows from the target device cooler to the condenser, wherein
the condenser is disposed in an inside air circulation path through which the inside air circulates while air conditioning is performed by an air conditioning unit that blows out temperature-controlled air to the vehicle interior.
